(19) United States
(12) Patent Application Publication
(10) Pub. No.: US 2025/0318506 A1
(43) Pub. Date: Oct. 16, 2025

(54) Canine Leash Buckle Apparatus

(71) Applicant: Yokum Gear LLC, Bennett, CO (US)

(72) Inventors: Dianne Yokum, Bennett, CO (US); Jerry Yokum, Bennett, CO (US)

(21) Appl. No.: 19/090,389

(22) Filed: Mar. 26, 2025

Related U.S. Application Data
(60) Provisional application No. 63/633,684, filed on Apr. 12, 2024.

(51) Int. Cl. A01K 27/00

(52) U.S. Cl. CPC A01K 27/002

(57) ABSTRACT

A Canine Leash Buckle Apparatus comprising a leash buckle with at least one leash hole and at least one harness hole, wherein the at least one leash hole is large enough to allow a leash, with a first and a second end, to slide easily through it and the at least one harness hole is sized to provide resistance to the leash passing through it, a clip with a first end and a second end, wherein the clip first end is removably connected to the leash and the second end operable to removably connect to the leash to create a loop in the leash.

### BACKGROUND OF THE PRESENT INVENTION

### Field of the Invention

The field of canine trainings, exercise, and the like.

### CROSS REFERENCE TO RELATED APPLICATIONS

This application is not related to any U.S. application.

### REFERENCE REGARDING FEDERALLY SPONSORED RESEARCH OR DEVELOPMENT

Not Applicable to this invention.

### BACKGROUND

Currently in the field of canine training and exercise there exists a strong need for a simple, inexpensive, and reliable method for harnessing canines in a non-harmful way that allows a handler or owner to control the canine's behavior.

For many years inventors have tried to create a reliable method without success. Current designs use technology like “choke” collars, which are collars that tighten around a canine's neck if the leash to which the collar is attached tightens for any reason. In practice choke collars cause the canine to choke as the leash is tightened. While this is typically effective in controlling the canine, it risks causing damage to canine's esophagus, larynx, or neck. In other cases, the choke collar is ineffective, for example if the canine is too large. To enhance the effectiveness of the collar, some designs add points or other protrusions to the collar to increase the discomfort to the canine as the collar tightens.

Other designs for controlling canines include harnesses attached to leashes, but these are typically ineffective, unless the trainer or owner is significantly stronger than the canine. If not, then the canine is able to drag the trainer or owner.

Remote training devices, such as electric shock collars or dog whistles can be used to train canines, but do not have a physical link between the canine and the trainer or owner. Thus, the canine may still escape the owner or trainer.

The below described new Canine Leash Buckle Apparatus was conceived and developed to overcome the limitations inherent in the above-described designs and processes.

### SUMMARY OF THE INVENTION

The Canine Leash Buckle Apparatus overcomes the above-described limitations by using a mixture of novel features. For example, the device allows a canine owner, trainer, or handler (hereinafter referred to as a “handler”) to easily communicate with and control the canine using a simple piece of rope or circular cross sectioned leash. The device achieves this by using a novel buckle that allows the leash to be looped around the neck of the dog in circular loop, then threaded through the buckle, looped around the waist of the canine at the location of its floating ribs, and then to the hand of the handler.

When the leash is pulled taught, the loops around the canine's waist is pulled tight. As the waist loop tightens, the canine's floating rib is pressed in, which causes pressure on the canine. The harder the canine pulls the more the pressure increases, until the leash tension is released, either through the canine obeying commands or moving closer to the handler. Unlike current designs, the Canine Leash Buckle Apparatus only causes pressure and does not risk injury to the canine.

This innovative approach allows handlers, owners, and trainers to communicate with their canines effectively, speaking in a language that the canines inherently understand. The continuous use of pressure and release of the check cord on the canine teaches the canine that applied pressure equals pulling and this is not desired. In addition to handler control, if the canine pulls the waist loop tightens, which increases pressure, or the canine can release the pressure by moving closer to the handler.

As an example of the invention in use, a handler can teach a hunting canine the desired distance by keeping the rope at the desired length, command it to change directions using the pressure, or comeback in the same way.

The use of gentle pressure ensures a training process that is not only effective but also considers the comfort and well-being of the canine.

In one embodiment, the Canine Leash Buckle Apparatus uses a rope leash with a detachable clip at one end and a handle or hand loop at the other. The buckle is a metal, plastic, or other durable material, plate divided into upper and lower sections with a single larger hole in the upper section and two holes parallel to each other in the lower section. The larger is one and a half to two times the diameter of the rope leash and the smaller holes are the diameter of the rope leash. The holes dimensions are not limited to these sizes but may be any size that allows the rope leash to be threaded through them correctly.

The rope leash is then made into a canine neck loop by using the clip attached to one end to clip back onto the rope leash forming a loop. The rope leash is threaded directly through the two smaller holes and then looped around the canine's waist and back through the large hole. The rope end that has passed through the large hole is connected to the leash handle or otherwise held by the owner, trainer, or handler. Used in this manner, the Canine Leash Buckle Apparatus can be fitted to a canine of any size from puppy to adult or small to large.

In one embodiment, the Canine Leash Buckle Apparatus comprises a leash buckle with at least one leash hole and at least one harness hole, wherein the at least one leash hole is large enough to allow a leash, with a first and a second end, to slide easily through it and the at least one harness hole is sized to provide resistance to the leash passing through it, a clip with a first end and a second end, wherein the clip first end is removably connected to the leash and the second end operable to removably connect to the leash to create a loop in the leash.

In this and other embodiments, the leash is one of a group consisting of a synthetic rope, a natural fiber rope, a leather rope, a leather strap, a string, or a tube.

In this and other embodiments, the leash buckle is made of a material consisting of metal, plastic, wood, or ceramic.

In this and other embodiments, the clip is one of a group consisting of a trigger clip, a safety break clip, a dog clip, a carabiner clip, a swivel J hook clip, a flat metal hook clip, a split ring, a lobster claw clip, or a Japan hook clip.

In this and other embodiments, the Canine Leash Buckle Apparatus may be used by: obtaining a Canine Leash Buckle Apparatus consisting of a leash buckle with at least one leash hole and at least one harness hole, wherein the at least one leash hole is large enough to allow a leash, with a first and a second end, to slide easily through it and the at least one harness hole is sized to provide resistance to the leash passing through it, a clip with a first end and a second end, wherein the clip first end is removably connected to the leash, at the first end, and the second end operable to removably connect to the leash to create a loop in the leash, then creating the loop using the clip and placing the loop around the neck of a canine, routing the leash second end down the spine of the canine, through the at least one harness hole, then around an abdomen of the canine and through the leash hole, the leash second end is then grasped by a trainer, and an increase in tension on the leash second end will cause the leash to tighten around the abdomen of the canine and a decrease in tension on the leash second end will cause the leash to loosen.

As will be obvious to anyone of skill in the art, numerous modifications to the features described are possible. Accordingly, the described and illustrated embodiments are to be construed as merely exemplary of the inventive concepts expressed herein and addressed in the appended claims.

For a better understanding of the invention, its operating advantages and the specific objects attained by its uses, reference should be made to the accompanying drawings and descriptive matter in which there are illustrated preferred embodiments of the invention.

Various objects, features, aspects and advantages of the present embodiment will become more apparent from the following detailed description of embodiments of the design, along with the accompanying drawings.

### DESCRIPTION OF THE DRAWINGS

Note: The drawing and figures may be in simplified form and should not be considered to be precisely to scale.

FIG. 1 is a front view of one embodiment of the Canine Leash Buckle Apparatus.

FIG. 2 is a side view of one embodiment of the Canine Leash Buckle Apparatus on a canine.

FIG. 3 is a top view of one embodiment of the Canine Leash Buckle Apparatus on a canine.

FIG. 4 is a top view of one embodiment of the Canine Leash Buckle Apparatus on a canine and an immature canine.

### DETAILED DESCRIPTION OF THE INVENTION

The present Canine Leash Buckle Apparatus greatly improves upon current designs in many ways. In the following description, numerous specific details are set forth to provide a more thorough description of embodiments of the Canine Leash Buckle Apparatus. It will be apparent, however, to one skilled in the art, that the embodiments of the Canine Leash Buckle Apparatus may be practiced without these specific details. In other instances, well-known features have not been described in detail so as not to obscure the many benefits of the Canine Leash Buckle Apparatus. In all instances, it should be expressly understood that the embodiments illustrated herein are merely exemplary of the inventive concepts expressed and that many alterations and modifications may be made by those having ordinary skill in the art without departing from the spirit and scope of the embodiments.

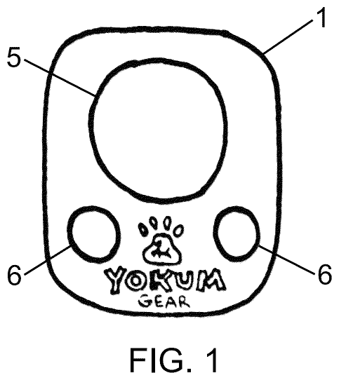

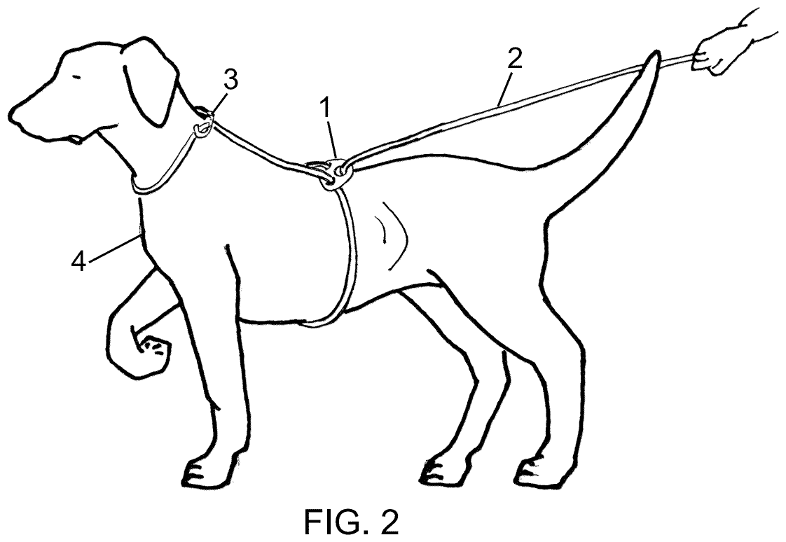

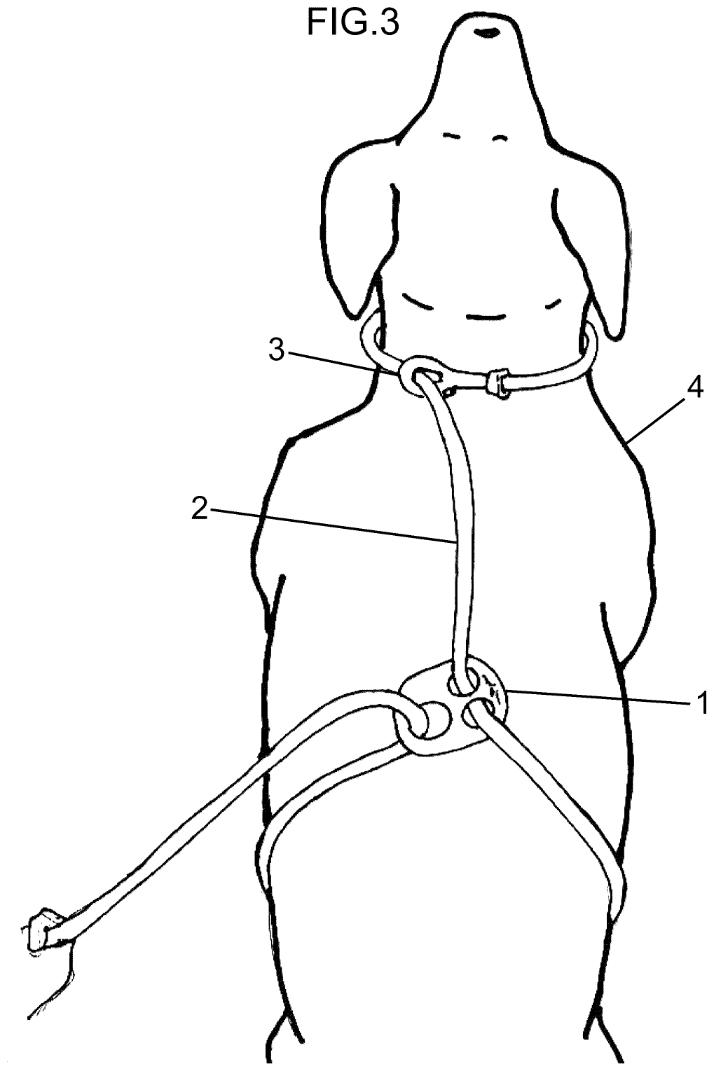

Referring now to FIGS. 1 through 3, which illustrate a one possible embodiment of the Canine Leash Buckle Apparatus, the apparatus consists of a leash buckle 1, containing a leash hole 5 and two harness holes 6.

A clip 3, or other attaching device, is attached to one end of a rope leash 2 and during use is looped around the neck of the canine 4 and used to secure the rope leash around the neck of the canine 4. The rope leash 2 is then routed along the back of the canine 4 and through the harness holes 6 of the leash buckle 1. The rope leash 2 is then looped around the waist of the canine 4 and then through the leash hole 5 of the leash buckle 1 and then to the hand of a handler.

If the canine 4 begins to pull away from the handler, or the leash is otherwise pulled taut, the waist loop in the rope leash 2 begins to tighten and cause pressure to the canine 4. The waist loop presses against the floating ribs of the canine 4 which causes pressure but will not harm the canine 4. As soon as the rope leash 2 is loosened the waist loop releases and the pressure will fade. Thus, the handler may easily control the canine 4 without harsh treatment or injury.

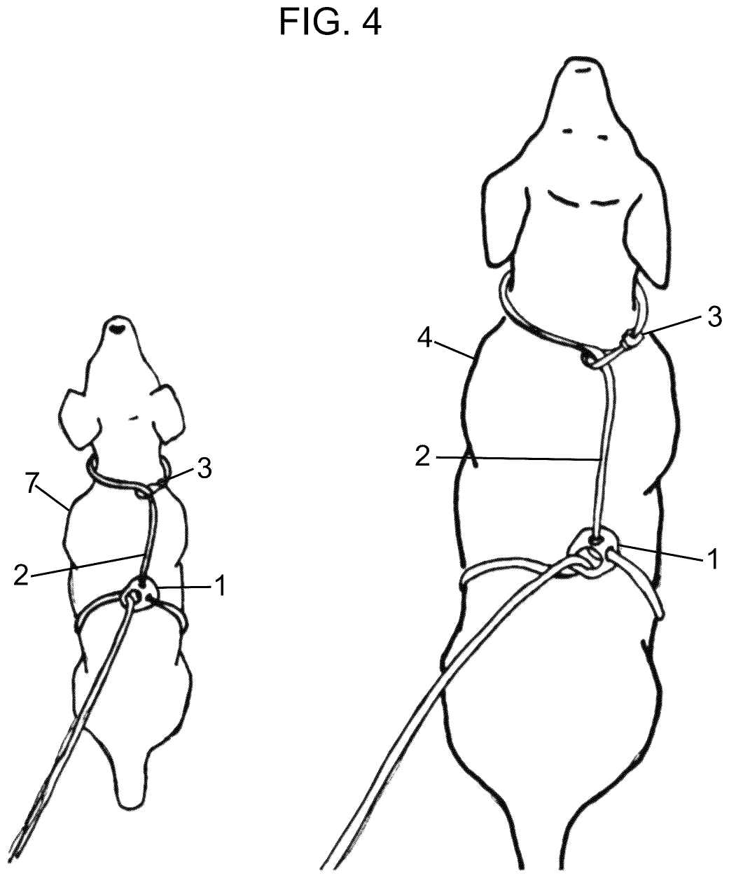

Referring now to FIG. 4, the Canine Leash Buckle Apparatus may be fitted to canines of different ages or sizes. Illustrated here, the apparatus may be fitted to an immature canine 7 without modification to the rope leash 2, clip 3, or leash buckle 1.

In this and other embodiments, the rope leash may be composed of natural or synthetic rope, cord, straps, or any other material or style that is compatible with the function of the leash buckle 1.

In this and other embodiments, the leash buckle 1 may be composed of aluminum, anodized or untreated, steel, iron, stainless steel, titanium, plastic, ceramic, or composed of any other material with sufficient strength. It may also be manufactured using any method, including machining, 3D printing, casting, or forging.

In this and other embodiments, the leash hole 5 diameter is larger than the diameter, or cross section, of the rope leash 2 and the harness holes 6 a similar size to the diameter or cross section. The specific sizes and shapes of the holes may vary so long as the function of the holes is preserved.

In this and other embodiments, the clip 3 may be a bolt snap, snap clip or hook, carabiner, clamp, lobster claw, or knot.

Numerous modifications to the features described and shown are possible. Accordingly, the described and illustrated embodiments are to be construed as merely exemplary of the inventive concepts expressed herein and addressed in the appended claims.

What is claimed is:

1. A Canine Leash Buckle Apparatus comprising:
a leash buckle with at least one leash hole and at least one harness hole, wherein said at least one leash hole is large enough to allow a leash, with a first and a second end, to slide easily through it and said at least one harness hole is sized to provide resistance to said leash passing through it;
a clip with a first end and a second end, wherein said clip first end is removably connected to said leash and said second end operable to removably connect to said leash to create a loop in the leash.

2. An apparatus according to claim 1, wherein said leash is one of a group consisting of a synthetic rope, a natural fiber rope, a leather rope, a leather strap, a string, or a tube.

3. An apparatus according to claim 1, wherein said leash buckle is made of a material consisting of metal, plastic, wood, or ceramic.

4. An apparatus according to claim 1, wherein said clip is one of a group consisting of a trigger clip, a safety break clip, a dog clip, a carabiner clip, a swivel J hook clip, a flat metal hook clip, a split ring, a lobster claw clip, or a Japan hook clip.

5. A method for using a Canine Leash Buckle Apparatus comprising:
obtaining a Canine Leash Buckle Apparatus consisting of a leash buckle with at least one leash hole and at least one harness hole, wherein said at least one leash hole is large enough to allow a leash, with a first and a second end, to slide easily through it and said at least one harness hole is sized to provide resistance to said leash passing through it;
a clip with a first end and a second end, wherein said clip first end is removably connected to said leash, at said first end, and said second end operable to removably connect to said leash to create a loop in the leash;
creating said loop using said clip and placing said loop around the neck of a canine;
routing said leash second end down the spine of said canine, through said at least one harness hole, then around an abdomen of said canine and through said leash hole;
said leash second end is then grasped by a trainer, and an increase in tension on said leash second end will cause said leash to tighten around said abdomen of said canine and a decrease in tension on said leash second end will cause said leash to loosen.
